(19) United States
(12) Patent Application Publication
(10) Pub. No.: US 2020/0391218 A1
(43) Pub. Date: Dec. 17, 2020

(54) DIFFERENTIAL VERTICAL SHAFT IMPACT (VSI) CRUSHER

(71) Applicant: Jinping SHENG, Anhui Province (CN)

(72) Inventor: Jinping SHENG, Anhui Province (CN)

(21) Appl. No.: 16/899,690

(22) Filed: Jun. 12, 2020

(30) Foreign Application Priority Data
Jun. 12, 2019 (CN) 201910504424.4

(51) Int. Cl. B02C 13/18; B02C 19/00; B02C 23/02

(52) U.S. Cl. CPC B02C 13/185; B02C 19/0018; B02C 2013/145; B02C 2013/1871; B02C 23/02

(57) ABSTRACT

A differential vertical shaft impact (VSI) crusher, including: a tank and a plurality of single-stage rotors, and a rotating shaft and a rotor block of each single-stage rotor are coaxial, where the rotating shafts of the plurality of single-stage rotors use a hollow shaft structure and are coaxially mounted in a sleeving and sheathing manner, the rotor blocks of the plurality of single-stage rotors are connected in series, the plurality of single-stage rotors form a multi-stage rotor, the multi-stage rotor is mounted inside the tank in a vertical rotation manner, rotating shafts of two single-stage rotors that are mounted in the sleeving and sheathing manner are in running fit with each other, each single-stage rotor has an independent drive apparatus and can rotate independently, an impact lining is mounted on an inner wall of the tank, and impact hammers are mounted around the rotor block of each single-stage rotor.

### CROSS REFERENCE TO RELATED APPLICATIONS

This application claims priority under 35 U.S.C. § 119 to Chinese Patent Application No. 201910504424.4, which was filed on 12 Jun. 2019.

### TECHNICAL FIELD

The present invention relates to the field of crushers for mineral crushing, and specifically, to a differential VSI crusher.

### BACKGROUND

With the rapid development of China's economy, an infrastructure scale is large, and a tremendous quantity of building materials are needed. China also has a high demand for minerals, and a mineral processing market is promising. Currently, at home and abroad, mineral crushing and processing devices always have problems of low efficiency, high energy consumption, high wearing, and high pollution.

With the upgrade of industries, the mineral market is segmented, and the products need to have customization property. In addition, a higher requirement is imposed on mineral processing equipment. Particularly, in the building aggregates and machine-made sand industries, high quality is needed to meet a requirement for high-grade concrete. In addition, a mining machine also needs to have a high reduction ratio, to reduce infrastructure investments, reduce environmental protection pressure, optimize a manufacturing process, and implement informatization and intelligence of manufacturing. However, conventional mineral crushing and processing equipment can hardly achieve this effect. Therefore, it is extremely urgent to develop a mineral crushing device having the following advantages: “being highly-efficient”, “having low energy consumption”, “having low noise”, “having a high reduction ratio”, “facilitating informatized management”, and “intelligently controlling adjustment of a product property”.

### SUMMARY

An objective of the present invention, among others, is to remedy defects of the prior art, and provide a differential VSI crusher. The VSI crusher has the following features: having a simple structure, being easily maintained, having a high reduction ratio, capable of crushing products of all specifications, being highly graded, capable of implementing intelligent and informatized production, and being easily mounted.

Technical solutions of various embodiments of the present invention are as follows:

A differential VSI crusher is provided, and includes: a tank and a plurality of single-stage rotors, where a feed port and a discharge port are respectively disposed on an upper end and a lower end of the tank, and a rotating shaft and a rotor block of each single-stage rotor are coaxial, where the rotating shafts of the plurality of single-stage rotors use a hollow shaft structure and are coaxially mounted in a sleeving and sheathing manner, the rotor blocks of the plurality of single-stage rotors are connected in series, the plurality of single-stage rotors form a multi-stage rotor, the multi-stage rotor is mounted inside the tank in a vertical rotation manner, rotating shafts of two single-stage rotors that are mounted in the sleeving and sheathing manner are in running fit with each other, each single-stage rotor has an independent drive apparatus and can rotate independently, an impact lining is mounted on an inner wall of the tank, and impact hammers are mounted around the rotor block of each single-stage rotor.

In the differential VSI crusher, a rotating shaft of at least one of the two single-stage rotors that are mounted in the sleeving and sheathing manner is a hollow shaft.

In the differential VSI crusher, the drive apparatus of each single-stage rotor includes a prime mover and a transmission apparatus thereof.

In the differential VSI crusher, the rotating shaft of each single-stage rotor has an extension end, and the drive apparatus is disposed on the extension end of the corresponding single-stage rotor.

In the differential VSI crusher, an opening is formed on a side wall of the tank, and an inspection door is mounted.

In embodiments of the present invention, a structure of a rotor of a crusher in the prior art is changed, to implement stage-based differential crushing, implement simultaneous multi-stage crushing, and implement stage-based independence of power drive.

Beneficial effects of embodiments of the present invention:

1. In embodiments of the present invention, stage-based differential crushing is implemented, products of full specifications can be crushed, produced products can meet requirements of different grades and different grain shapes, and high-class raw materials can be provided for high-quality and high-grade concrete.

2. In embodiments of the present invention, simultaneous multi-stage crushing of a single machine is implemented, thereby greatly increasing a reduction ratio, simplifying a crushing process, and reducing device and infrastructure investments.

3. In embodiments of the present invention, stage-based independence of power drive is implemented, to provide a precondition of implementing comprehensive and intelligent control.

### BRIEF DESCRIPTION OF THE DRAWINGS

FIG. 1 is a schematic structural diagram of an embodiment of the present invention.

FIG. 2 is a schematic structural diagram of a long-shaft rotor according to an embodiment of the present invention; and

FIG. 3 is a schematic structural diagram of a short-shaft rotor according to an embodiment of the present invention.

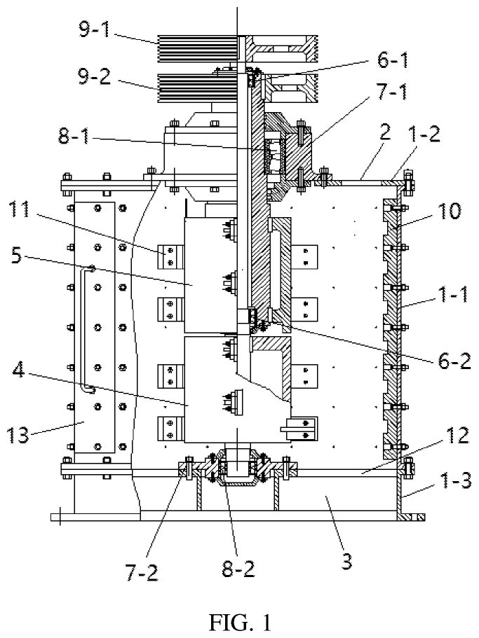

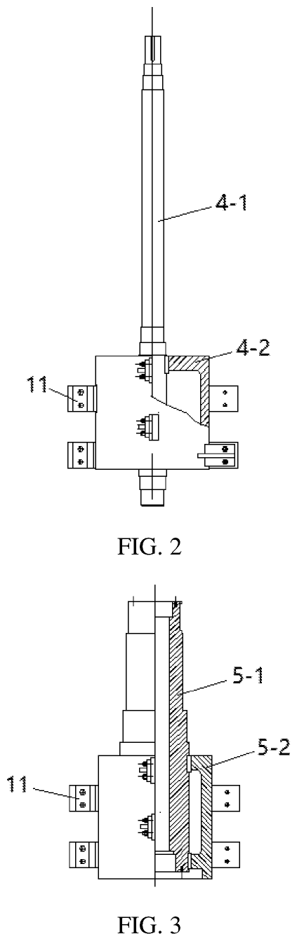

### DETAILED DESCRIPTION

Referring to the accompanying drawings, the embodiments of the present invention are described by using an example in which there are two single-stage rotors, namely, a long-shaft rotor and a short-shaft rotor. Details are as follows:

A differential VSI crusher includes a tank and two single-stage rotors. The tank includes a barrel 1-1, and a cover plate 1-2 and a base 1-3 that are respectively mounted at the top of and at the bottom of the barrel 1-1 by using bolts. A feed port 2 is disposed on the cover plate 1-2, and the inside of the base 1-3 is of a hollow structure communicating with a lower port of the barrel 1-1, to form a discharge port 3.

The two single-stage rotors are respectively a long-shaft rotor 4 and a short-shaft rotor 5. A rotating shaft 4-1 and a rotor block 4-2 of the long-shaft rotor 4 are coaxial, and a rotating shaft 5-1 and a rotor block 5-2 of the short-shaft rotor 5 are coaxial. The rotating shaft 4-1 of the long-shaft rotor 4 may be a solid shaft or may be a hollow shaft, the rotating shaft 5-1 of the short-shaft rotor 5 is a hollow shaft, and is sleeved on the rotating shaft 4-1 of the long-shaft rotor 4, and the rotating shaft 5-1 of the short-shaft rotor 5 and the rotating shaft 4-1 of the long-shaft rotor 4 are coaxial, to connect the rotor block 4-2 of the long-shaft rotor 4 and the rotor block 5-2 of the short-shaft rotor 5 in series. The long-shaft rotor 4 and the short-shaft rotor 5 form a two-stage rotor.

Bearings 6-1 and 6-2 are respectively disposed on two ends between the rotating shaft 4-1 of the long-shaft rotor 4 and the rotating shaft 5-1 of the short-shaft rotor 5, so that the rotating shaft 4-1 of the long-shaft rotor 4 and the rotating shaft 5-1 of the short-shaft rotor 5 are in running fit with each other. A through hole is disposed in the middle of the cover plate 1-2, and an upper bearing seat 7-1 is fixed thereto. An upper end of the rotating shaft 4-1 of the long-shaft rotor 4 and an upper end of the rotating shaft 5-1 of the short-shaft rotor 5 respectively extend from the through hole and the upper bearing seat 7-1 to the outside, and the rotating shaft 5-1 of the short-shaft rotor 5 is rotationally mounted inside the upper bearing seat 7-1 by using an upper bearing 8-1. A support beam 12 is fixed to the lower port of the barrel 1-1, a lower bearing seat 7-2 is fixed to the middle of the support beam 12, and a lower end of the rotating shaft 4-1 of the long-shaft rotor 4 is rotationally mounted inside the lower bearing seat 7-2 by using a lower bearing 8-2, so that the two-stage rotor is mounted inside the tank in a vertical rotation manner The upper and lower bearing seats 7-1 and 7-2 and the upper and lower bearings 8-1 and 8-2 support the long-shaft rotor 1 and the short-shaft rotor 2, so that the long-shaft rotor 1 and the short-shaft rotor 2 can rotate inside the tank.

Extension ends are disposed on both the upper end of the rotating shaft 4-1 of the long-shaft rotor 4 and the upper end of the rotating shaft 5-1 of the short-shaft rotor 5, and belt pulleys 9-1 and 9-2 are respectively mounted. The belt pulleys 9-1 and 9-2 are respectively connected to two independently disposed motors through belt drive, and when driven by the two independently disposed motors, the long-shaft rotor 4 and the short-shaft rotor 5 can rotate independently.

An impact lining 10 is mounted on an inner wall of the tank, impact hammers 11 are mounted around the rotor block 4-2 of the long-shaft rotor 4 and the rotor block 5-2 of the short-shaft rotor 5, and an opening is formed on a side wall of the tank and an inspection door 13 is mounted.

The following further describes various embodiments of the present invention with reference to the accompanying drawings.

When driven by the two independently disposed motors, the belt pulleys 9-1 and 9-2 rotate independently, to respectively drive the long-shaft rotor 4 and the short-shaft rotor 5 to rotate independently. The long-shaft rotor 4 and the short-shaft rotor 5 rotate at different speeds, in other words, the long-shaft rotor 4 and the short-shaft rotor 5 perform differential rotation, and speed adjustment control may be performed separately. The long-shaft rotor 4 and the short-shaft rotor 5 may rotate in a same direction or different directions, to cooperate with working of the impact lining 10 and the impact hammers 11, thereby meeting different working conditions in a mineral crushing and processing procedure, and implementing stage-based differential crushing and simultaneous multi-stage crushing of a single machine.

During working, to-be-crushed materials are fed into the tank through the feed port 2. When driven by the two independently disposed motors, the long-shaft rotor 4 and the short-shaft rotor 5 perform independent differential rotation, to drive respective impact hammers to rotate. The materials first fall into a crushing region formed by the short-shaft rotor 5, the impact hammers on the short-shaft rotor 5, and the impact lining 10, and the high-speed rotating short-shaft rotor 5, the impact hammers on the short-shaft rotor 5, and the impact lining 10 perform initial impact and impact crushing on the materials. The materials undergoing the initial impact and impact crushing fall into a crushing region formed by the long-shaft rotor 4, the impact hammers on the long-shaft rotor 4, and the impact lining 10, and the high-speed rotating long-shaft rotor 4, the impact hammers on the long-shaft rotor 4, and the impact lining 10 perform secondary impact and impact crushing on the materials. Rotational speeds of the long-shaft rotor 4 and the short-shaft rotor 5 are adjusted based on different working condition requirements in a mineral crushing and processing procedure, to enable the long-shaft rotor 4 and the short-shaft rotor 5 to rotate at different speeds, so that stage-based differential crushing is implemented, products of full specifications can be crushed, produced products can meet requirements of different grades and different grain shapes, and high-class raw materials can be provided for high-quality and high-grade concrete. In addition, simultaneous multi-stage crushing of a single machine is implemented, thereby greatly increasing a reduction ratio of the single machine, simplifying a crushing process, and reducing device and infrastructure investments.

The disclosed embodiment of the present invention is described only by using an example in which there are two single-stage rotors, namely, the long-shaft rotor 4 and the short-shaft rotor 5. When there are more than two single-stage rotors, structures and working principles thereof are similar to the structures and the working principles of the two single-stage rotors, and details are not described herein again.

The examples described above are only descriptions of preferred examples of the present invention, and do not intended to limit the scope of the present invention. Various variations and modifications can be made to the technical solution of the present invention by those of ordinary skills in the art, without departing from the design and spirit of the present invention. The variations and modifications should all fall within the claimed scope defined by the present invention.

1. A differential vertical shaft impact (VSI) crusher, comprising: a tank and a plurality of single-stage rotors, wherein a feed port and a discharge port are respectively disposed on an upper end and a lower end of the tank, and a rotating shaft and a rotor block of each single-stage rotor are coaxial, wherein the rotating shafts of the plurality of single-stage rotors use a hollow shaft structure and are coaxially mounted in a sleeving and sheathing manner, the rotor blocks of the plurality of single-stage rotors are connected in series, the plurality of single-stage rotors form a multi-stage rotor, the multi-stage rotor is mounted inside the tank in a vertical rotation manner, rotating shafts of two single-stage rotors that are mounted in the sleeving and sheathing manner are in running fit with each other, each single-stage rotor has an independent drive apparatus and can rotate independently, an impact lining is mounted on an inner wall of the tank, and impact hammers are mounted around the rotor block of each single-stage rotor.

2. The differential VSI crusher according to claim 1, wherein a rotating shaft of at least one of the two single-stage rotors that are mounted in the sleeving and sheathing manner is a hollow shaft.

3. The differential VSI crusher according to claim 1, wherein the drive apparatus of each single-stage rotor comprises a prime mover and a transmission apparatus thereof.

4. The differential VSI crusher according to claim 1, wherein the rotating shaft of each single-stage rotor has an extension end, and the drive apparatus is disposed on the extension end of the corresponding single-stage rotor.

5. The differential VSI crusher according to claim 1, wherein an opening is formed on a side wall of the tank, and an inspection door is mounted.

6. The differential VSI crusher according to claim 3, wherein the rotating shaft of each single-stage rotor has an extension end, and the drive apparatus is disposed on the extension end of the corresponding single-stage rotor.
